(19) United States
(12) Patent Application Publication
(10) Pub. No.: US 2026/0092644 A1
(43) Pub. Date: Apr. 2, 2026

(54) JOINT UNIT

(71) Applicant: Sony Interactive Entertainment Inc., Tokyo (JP)

(72) Inventors: Katsutsugu Fukamachi, Kanagawa (JP); Hiroshi Osawa, Kanagawa (JP)

(73) Assignee: Sony Interactive Entertainment Inc., Tokyo (JP)

(21) Appl. No.: 19/002,070

(22) Filed: Dec. 26, 2024

(30) Foreign Application Priority Data
Jan. 10, 2024 (JP) 2024-001878

(51) Int. Cl. F16H 57/12; B25J 9/10; F16H 19/08

(52) U.S. Cl. CPC F16H 57/12; B25J 9/102; F16H 19/08; F16H 2057/127

(57) ABSTRACT

Provided is a joint unit including two opposite gears that are two bevel gears opposite to each other, an intermediate gear that is a bevel gear that meshes with both of the two opposite gears, a first shaft that rotatably supports a first gear that is any gear of the two opposite gears and the intermediate gear, a bearing disposed between the first gear and the first shaft, and, an elastic member, in which the first gear has an opposite surface opposite to the bearing in a direction along a first axis line defined in the first shaft, and the elastic member biases the opposite surface through the bearing in the direction along the first axis line.

### CROSS REFERENCE TO RELATED APPLICATIONS

This application claims priority to Japanese Priority Patent Application JP 2024-001878, filed January 10, 2024, the contents of which are incorporated by reference herein in its entirety for all purposes.

### BACKGROUND OF THE INVENTION

The present disclosure relates to a joint unit.

In Japanese Patent Laid-open No. 2022-153045, a joint unit that can move an arm of a robot or the like is disclosed. The joint unit has opposite gears that are two bevel gears opposite to each other and an intermediate gear that is a bevel gear disposed between the two opposite gears. The teeth of the intermediate gear mesh with the teeth of the two opposite gears. The two opposite gears receive power of motors different from each other and can rotate independently of each other. When the two opposite gears rotate in directions different from each other (for example, when one rotates in a clockwise manner and the other rotates in an anticlockwise manner), the intermediate gear rotates around the axis line of the intermediate gear. Further, when the two opposite gears rotate in the same direction (for example, when both of the two gears rotate in a clockwise manner or both of the two gears rotate in an anticlockwise manner), the intermediate gear rotationally moves around the axis line of the opposite gears. By these two kinds of motion of the intermediate gear, a member such as an arm connected to the intermediate gear can be moved in two directions (for example, a front-rear direction and a left-right direction).

### SUMMARY OF THE INVENTION

In the case in which the gap (backlash) between the teeth is large between the opposite gear and the intermediate gear, collision between the teeth of the opposite gears and the teeth of the intermediate gear occurs when the opposite gears start rotation. This causes the occurrence of noise and vibrations. In regard to this point, in a configuration of Japanese Patent Laid-open No. 2022-153045, a member forming an inner circumferential portion of an opposite gear can be separated from a member forming an outer circumferential portion of the opposite gear. Moreover, an elastic member is disposed between these members, and the member forming the inner circumferential portion of the opposite gear is biased by the elastic member. As a result, the backlash between the opposite gear and the intermediate gear is inhibited from becoming large. However, the opposite gear is configured by the two members, and the structure of the opposite gear is complicated.

It is desirable to inhibit a backlash from becoming large with a gear having a simple structure.

A joint unit may have two opposite gears that are two bevel gears opposite to each other, an intermediate gear that is a bevel gear that meshes with both of the two opposite gears, a first shaft that rotatably supports a first gear that is any gear of the two opposite gears and the intermediate gear, a bearing disposed between the first gear and the first shaft, and an elastic member. The first gear may have an opposite surface opposite to the bearing in a direction along a first axis line defined in the first shaft. The elastic member may bias the opposite surface through the bearing in the direction along the first axis line. This can inhibit a backlash from becoming large with the gear having a simple structure.

### BRIEF DESCRIPTION OF THE DRAWINGS

FIG. 1 is a perspective view depicting a joint unit according to a first embodiment proposed in the present disclosure;

FIG. 2 is a front view depicting the joint unit according to the first embodiment;

FIG. 3 is a partially enlarged view of FIG. 2;

FIG. 4 is a sectional view depicting a section taken along line IV-IV in FIG. 2;

FIG. 5 is a partially enlarged view of FIG. 4;

FIG. 6 is a perspective view depicting a joint unit according to a second embodiment proposed in the present disclosure;

FIG. 7 is a sectional view depicting a section of the joint unit according to the second embodiment;

FIG. 8 is a partially enlarged view of FIG. 7;

FIG. 9 is a partially enlarged view of FIG. 7; and

FIG. 10 is a sectional view depicting a section of part of a joint unit according to a modification.

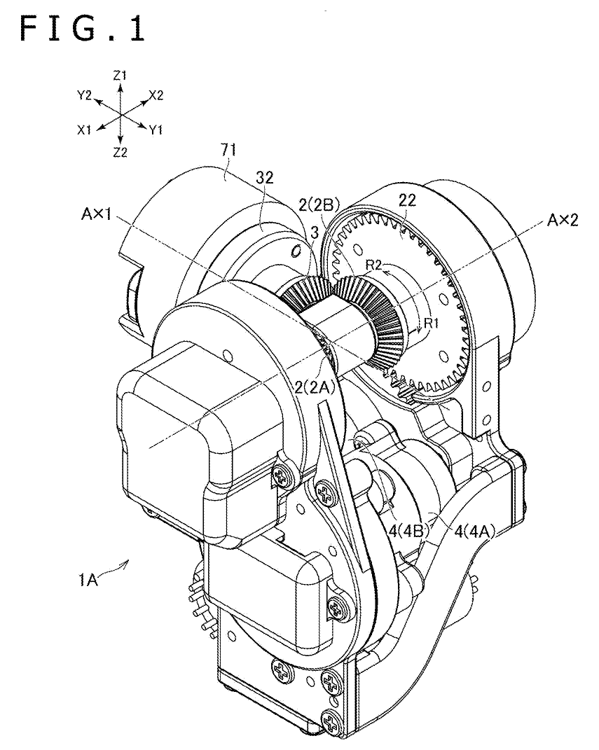

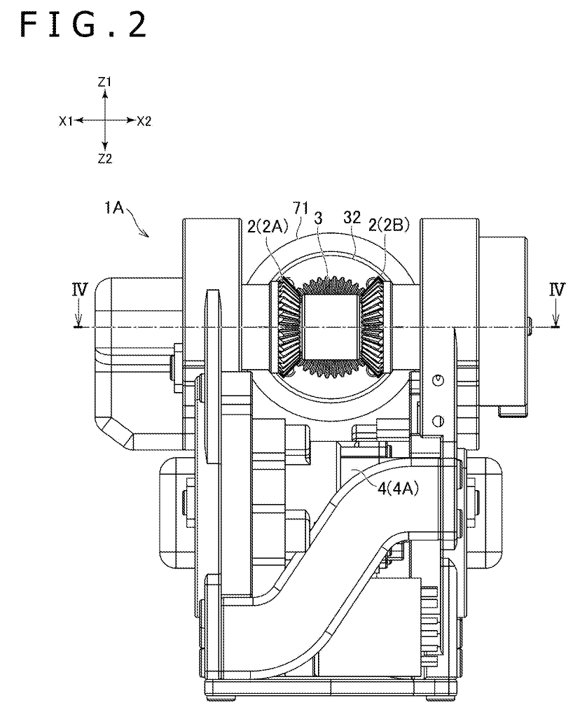

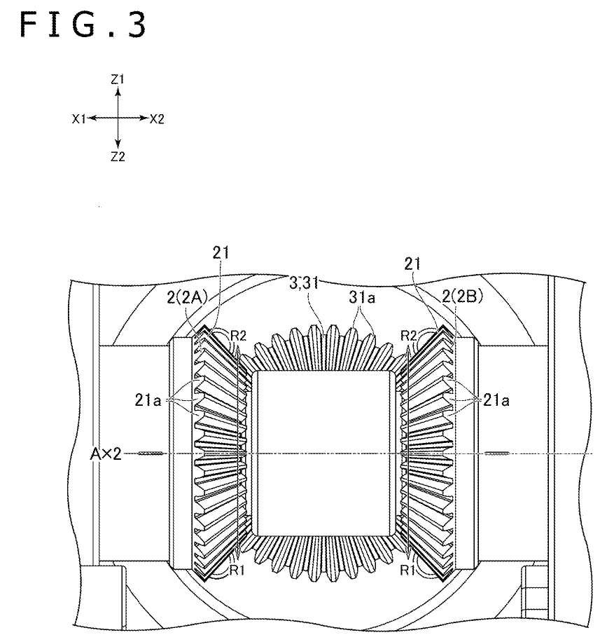

### DETAILED DESCRIPTION OF THE PREFERRED EMBODIMENTS

[1. First Embodiment] First, a first embodiment proposed in the present disclosure is described with reference to drawings. FIG. 1 is a perspective view depicting a joint unit 1A according to the first embodiment. FIG. 2 is a front view of the joint unit 1A. FIG. 3 is a partially enlarged view of FIG. 2, and depicts two opposite gears 2 (2A and 2B) and an intermediate gear 3 disposed in the joint unit 1A. In the following description, X1 and X2 indicated in the respective diagrams are referred to as the left side and the right side, respectively. Y1 and Y2 are referred to as the front side and the rear side, respectively. Z1 and Z2 are referred to as the upper side and the lower side, respectively.

[1-1. Outline of Joint Unit] The joint unit 1A may be attached to a robot for moving an arm of the robot. For example, the joint unit 1A is attached to a robot that imitates a human or an animal, and functions as a joint that moves an arm, foot, neck, waist, or the like of the robot.

As depicted in FIGS. 1 and 2, the joint unit 1A may have the two opposite gears 2 (2A and 2B) that are two bevel gears opposite to each other and the intermediate gear 3 that is a bevel gear that meshes with both of these two opposite gears 2. In the example depicted in FIGS. 1 and 2, the two opposite gears 2 are opposite to each other in the left-right direction. Further, the intermediate gear 3 is disposed between the two opposite gears 2 in the left-right direction. The opposite gear 2A is located on the left side of the intermediate gear 3. The opposite gear 2B is located on the right side of the intermediate gear 3. The two opposite gears 2 are not limited to having such a configuration and may be opposite to each other in the upward-downward direction across the intermediate gear 3 or be opposite to each other in an oblique direction with respect to the left-right and upward-downward directions.

As depicted in FIG. 3, each of the two opposite gears 2 may have, at an end portion thereof, a bevel teeth portion 21 in which a plurality of teeth 21a that line up along the rotation direction of the opposite gear 2 are disposed. The intermediate gear 3 may also have, at an end portion thereof, a bevel teeth portion 31 in which a plurality of teeth 31a that line up along the rotation direction of the intermediate gear 3 are disposed. The width of the plurality of teeth 21a disposed in the bevel teeth portion 21 of each opposite gear 2 may gradually become larger toward the outer circumference of the bevel teeth portion 21. The width of the plurality of teeth 31a disposed in the bevel teeth portion 31 of the intermediate gear 3 may also gradually become larger toward the outer circumference of the bevel teeth portion 31.

The intermediate gear 3 may be rotatable around a first axis line Ax1 depicted in FIG. 1. Further, the two opposite gears 2 may be rotatable around a second axis line Ax2 depicted in FIG. 1. In the example depicted in FIG. 1, the first axis line Ax1 extends in the front-rear direction, and the second axis line Ax2 extends in the left-right direction. In the example depicted in FIG. 1, the first axis line Ax1 and the second axis line Ax2 perpendicularly intersect each other. The first axis line Ax1 and the second axis line Ax2 are not limited to being configured as described above and may be at skew positions. Moreover, the angle formed by the first axis line Ax1 and the second axis line Ax2 does not necessarily have to be 90 degrees.

As depicted in FIG. 1, the joint unit 1A may have two motors 4 (4A and 4B). In the example depicted in FIG. 1, the motor 4A drives the opposite gear 2A, and the motor 4B drives the opposite gear 2B. The joint unit 1A has drive gears 22 each fixed to a respective one of the two opposite gears 2, and the motors 4 connect to each drive gear 22. This allows the two opposite gears 2 to receive power of the different motors 4 and rotate around the second axis line Ax2 independently of each other.

The two opposite gears 2 may be capable of rotating in the same direction and be rotatable in directions opposite to each other. Moreover, the two opposite gears 2 may be rotatable in the same direction at rotation speeds different from each other. In addition, only one of the two opposite gears 2 may be allowed to rotate in the state in which the other is stopped. Here, the “two opposite gears 2 rotating in the same direction” means that both of the two opposite gears 2 rotate in a direction indicated by R1 in FIG. 3 or rotate in a direction indicated by R2 in FIG. 3. Further, the “two opposite gears 2 rotating in directions opposite to each other” means that one gear of the two opposite gears 2 rotates in the direction indicated by R1 in FIG. 3 and the other gear rotates in the direction indicated by R2 in FIG. 3.

When the two opposite gears 2 rotate in directions opposite to each other, the intermediate gear 3 rotates around the first axis line Ax1. Moreover, when the two opposite gears 2 rotate in the same direction, the intermediate gear 3 moves (revolves) around the second axis line Ax2. As depicted in FIG. 1, the intermediate gear 3 may be fixed to a connection member 71 by a fixing implement such as a screw. The intermediate gear 3 may have the bevel teeth portion 31 at one end portion and have a base portion 32 at the other end portion. The connection member 71 may be fixed to the base portion 32 of the intermediate gear 3.

The connection member 71 to which the intermediate gear 3 is fixed may rotate or move together with the intermediate gear 3. The joint unit 1A in which the intermediate gear 3 is disposed may rotate or move relative to the connection member 71. By the rotation of the two opposite gears 2 in directions opposite to each other, the joint unit 1A can move around the first axis line Ax1 relative to a member fixed to the connection member 71. Such motion of the joint unit 1A is referred to as a roll action. Further, by the rotation of the two opposite gears 2 in the same direction, the joint unit 1A can move around the second axis line Ax2 relative to the member fixed to the connection member 71. Such motion of the joint unit 1A is referred to as a pitch action. The joint unit 1A can make the roll action, the pitch action, and an action arising from combining the roll action and the pitch action.

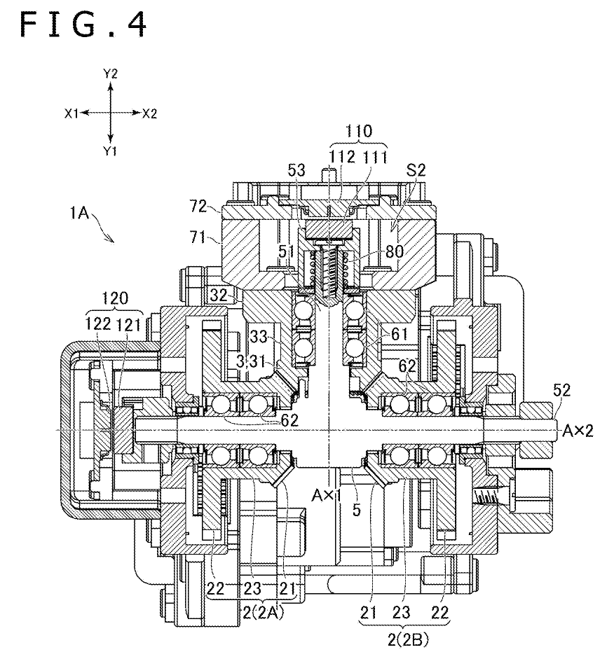

For example, a member (for example, an arm or torso) (hereinafter, referred to as a first member) of a robot that is not depicted may be fixed to the connection member 71. By the rotation of the connection member 71 around the first axis line Ax1 and the movement of the connection member 71 together with the intermediate gear 3 around the second axis line Ax2, the first member fixed to the connection member 71 can move around the first axis line Ax1 and the second axis line Ax2. In addition, the joint unit 1A may be disposed at an end portion of the first member. In this case, the connection member 71 may be fixed to a second member that is a member of the robot different from the first member. Also by the movement or rotation of the connection member 71 relative to this second member, the first member can move around the first axis line Ax1 and the second axis line Ax2.

[1-2. Internal Structure] FIG. 4 is a sectional view depicting a section taken along line IV-IV in FIG. 2 (line overlapping with the second axis line Ax2). As depicted in FIG. 4, the joint unit 1A may have a shaft 5 (one example of the first shaft) that rotatably supports the two opposite gears 2 and the intermediate gear 3. The shaft 5 may have a T-shape and have a first shaft portion 51 extending along the first axis line Ax1 and a second shaft portion 52 extending along the second axis line Ax2. The first axis line Ax1 may intersect the second axis line Ax2. The first axis line Ax1 may perpendicularly intersect the second axis line Ax2. The first shaft portion 51 may extend along the first axis line Ax1 from a central position in the second shaft portion 52 in the direction along the second axis line Ax2.

Further, as depicted in FIG. 4, the joint unit 1A may have bearings 61 disposed between the intermediate gear 3 and the shaft 5 (specifically, the first shaft portion 51) and bearings 62 disposed between each opposite gear 2 and the shaft 5 (specifically, the second shaft portion 52). The bearings 61 and 62 permit the rotation of the two opposite gears 2 and the intermediate gear 3 relative to the shaft 5. The bearings 61 and 62 may be radial bearings. In the example depicted in FIG. 4, the joint unit 1A has two bearings 61 that are arranged along the first axis line Ax1 and are in contact with each other in this direction and two bearings 62 that are arranged along the second axis line Ax2 and are in contact with each other in this direction. The numbers of bearings 61 and 62 are not limited to two, and may be one or be three or more.

As depicted in FIG. 4, each opposite gear 2 may have a cylindrical portion 23 extending along the second axis line Ax2. The bearings 62 may be housed inside this cylindrical portion 23. The bevel teeth portion 21 (see FIG. 3) may be formed at one end portion of the cylindrical portion 23 of each opposite gear 2, and the drive gear 22 that connects to the motor 4 may be formed at the other end portion. The bevel teeth portion 21, the drive gear 22, and the cylindrical portion 23 may be monolithically formed in each opposite gear 2.

Moreover, as depicted in FIG. 4, the intermediate gear 3 may have a cylindrical portion 33 extending along the first axis line Ax1, and the bearings 61 may be housed inside this cylindrical portion 33. The bevel teeth portion 31 may be formed at one end portion of the cylindrical portion 33, and the base portion 32 may be formed at the other end portion. The base portion 32 may have a larger diameter than the cylindrical portion 33 in the circumferential direction of the first axis line Ax1. The bevel teeth portion 31, the base portion 32, and the cylindrical portion 33 may be monolithically formed in the intermediate gear 3.

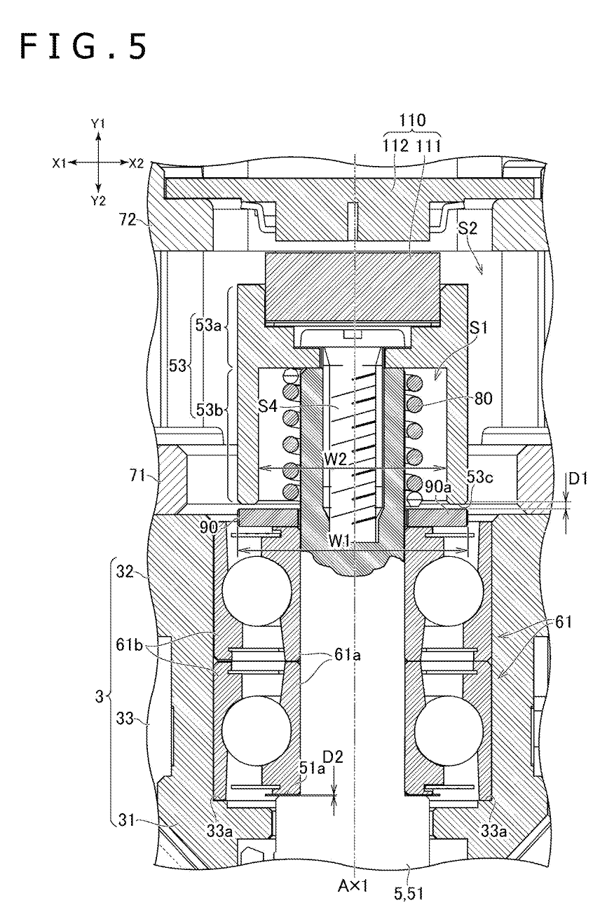

FIG. 5 is a partially enlarged view of FIG. 4. As depicted in FIG. 5, the intermediate gear 3 may have an opposite surface 33a opposite to the bearing 61 in the direction along the first axis line Ax1 defined in the shaft 5 (specifically, first shaft portion 51). The opposite surface 33a may be in contact with the bearing 61. The opposite surface 33a may be formed inside the cylindrical portion 33.

Further, as depicted in FIG. 5, the joint unit 1A may have an elastic member 80. The elastic member 80 may bias the bearings 61 in the direction along the first axis line Ax1. The elastic member 80 may bias the bearings 61 in the direction toward the side on which the bevel teeth portions 21 of the two opposite gears 2 are disposed (direction that is along the first axis line Ax1 and is oriented toward the intersection of the first axis line Ax1 and the second axis line Ax2; hereinafter this direction is simply referred to also as the direction toward the opposite gears 2). This allows the elastic member 80 to bias the opposite surface 33a through the bearings 61 in the direction along the first axis line Ax1 (specifically, the direction toward the opposite gears 2). That is, the elastic member 80 can bias the intermediate gear 3 in which the opposite surface 33a is formed, in the direction along the first axis line Ax1 (specifically, the direction toward the opposite gears 2).

By biasing the intermediate gear 3 in the direction toward the opposite gears 2 as described above, the teeth 31a of the bevel teeth portion 31 of the intermediate gear 3 can be pushed to fill the gaps between two teeth 21a adjacent to each other in the bevel teeth portion 21 of each opposite gear 2 depicted in FIG. 3. This can reduce the backlashes that are the gaps between the tooth 21a of the bevel teeth portion 21 of the opposite gears 2 and the tooth 31a of the bevel teeth portion 31 of the intermediate gear 3 and suppress the occurrence of noise and vibrations attributable to the backlashes.

In the example depicted in FIGS. 4 and 5, the elastic member 80 is a coil spring that is disposed around the first shaft portion 51 in the shaft 5 and surrounds the outer circumference of the first shaft portion 51. The elastic member 80 is not limited thereto. It is sufficient for the elastic member 80 to be a member that biases the bearings 61 (see FIG. 4) in the direction along the first axis line Ax1, and the elastic member 80 may be a spring of a kind different from the coil spring. Moreover, the elastic member 80 may be attached to a member different from the shaft 5.

As depicted in FIG. 5, the bearings 61 may have an inner circumferential portion 61a in contact with the shaft 5 (specifically, the first shaft portion 51) and an outer circumferential portion 61b in contact with the intermediate gear 3. Spherical balls or rollers with a circular cylindrical shape may be disposed between the inner circumferential portion 61a and the outer circumferential portion 61b. This allows the inner circumferential portion 61a and the outer circumferential portion 61b to rotate independently of each other around the first axis line Ax1. In addition, the inner circumferential portion 61a and the outer circumferential portion 61b may be integrally movable in the direction along the first axis line Ax1.

As depicted in FIG. 5, the elastic member 80 may bias the inner circumferential portion 61a of the bearing 61. Further, the bearing 61 may be opposite to the opposite surface 33a at the outer circumferential portion 61b and bias the opposite surface 33a by the outer circumferential portion 61b. This allows the outer circumferential portion 61b of the bearing 61 to rotate around the first axis line Ax1 relative to the inner circumferential portion 61a biased by the elastic member 80. The elastic member 80 can bias the opposite surface 33a of the intermediate gear 3 that is rotating around the first axis line Ax1, without rotating around the first axis line Ax1. This can bias the intermediate gear 3 in the direction toward the opposite gears 2 by the elastic member 80 while suppressing the occurrence of friction between the elastic member 80 and another member (for example, a fixed member 53 to be described later).

As depicted in FIG. 5, the joint unit 1A may have the fixed member 53 (one example of the first fixed member) that is attached to the shaft 5 (specifically, the first shaft portion 51) and is fixed to the shaft 5. The fixed member 53 may be fixed to an end portion of the first shaft portion 51 by a fixing implement 54 such as a screw. The fixing implement 54 may be inserted into the fixed member 53 and the shaft 5 along the first axis line Ax1.

Moreover, as depicted in FIG. 5, the elastic member 80 may be disposed between the fixed member 53 and the bearing 61 in the direction along the first axis line Ax1. The fixed member 53 may be formed into a cylindrical shape internally including a space S1. In addition, the elastic member 80 may be housed in the space S1 inside the fixed member 53. An end portion of the elastic member 80 may be in contact with the fixed member 53 in the space S1. The elastic member 80 may cause the bearings 61 to be biased in such a direction as to get farther away from the fixed member 53.

As depicted in FIG. 4, the connection member 71 may be fixed to the base portion 32 of the intermediate gear 3 at one end thereof, and a lid member 72 may be attached to the other end of the connection member 71. Further, the connection member 71 may be formed into a cylindrical shape internally including a space S2. In addition, the fixed member 53 and a sensor fixed portion 111 to be described later may be housed in the space S2 inside the connection member 71.

The intermediate gear 3 and the bearings 61 may be permitted to move in the direction along the first axis line Ax1 only across a distance shorter than the amount of deformation of the elastic member 80 (for example, a difference between the length of the elastic member 80 in the state in which no load is generated on the elastic member 80 and the length of the elastic member 80 when the elastic member 80 is compressed to the largest extent). By employing this, the backlashes that are the gaps between the tooth 21a of the bevel teeth portion 21 of the opposite gears 2 and the tooth 31a of the bevel teeth portion 31 of the intermediate gear 3 can be made appropriate.

As depicted in FIG. 5, the fixed member 53 may have a fixed portion 53a fixed to the end portion of the shaft 5 and an extending portion 53b that extends from this fixed portion 53a toward the bearing 61. Here, the distance across which the intermediate gear 3 and the bearings 61 can move in the direction along the first axis line Ax1 (for example, the distance across which they can move in the direction opposite to the direction toward the opposite gears 2) may be limited by an end surface 53c of the extending portion 53b. By employing this, the backlashes that are the gaps between the tooth 21a of the bevel teeth portion 21 of the opposite gears 2 and the tooth 31a of the bevel teeth portion 31 of the intermediate gear 3 can be made appropriate.

As depicted in FIG. 5, the joint unit 1A may have a movable member 90 disposed between the fixed member 53 (specifically, the end surface 53c of the extending portion 53b) and the bearing 61. The movable member 90 may be a washer that is attached to the first shaft portion 51 of the shaft 5 and surrounds the outer circumference of the first shaft portion 51. In addition, the movable member 90 may be movable in the direction along the first axis line Ax1. The movable member 90 may be capable of moving in the direction toward the opposite gears 2 by being pushed by the elastic member 80. Moreover, the movable member 90 may be capable of moving in the direction toward the side on which the fixed member 53 is disposed, by being pushed by the intermediate gear 3 and the bearings 61.

As depicted in FIG. 5, a diameter W1 of the movable member 90 in the circumferential direction of the first axis line Ax1 may be larger than a diameter W2 in the same direction regarding the space S1 formed in the fixed member 53. According to this, an end surface 90a of the movable member 90 may be opposite to the end surface 53c of the fixed member 53 in the direction along the first axis line Ax1. Further, a gap D1 may be provided between the end surface 90a of the movable member 90 and the end surface 53c of the fixed member 53. Here, the distance across which the intermediate gear 3 and the bearings 61 can move in the direction along the first axis line Ax1 (for example, the distance across which they can move in the direction opposite to the direction toward the opposite gears 2) may be limited within the range of the gap D1 between the end surface 53c of the fixed member 53 and the movable member 90. By employing this, the backlashes that are the gaps between the tooth 21a of the bevel teeth portion 21 of the opposite gears 2 and the tooth 31a of the bevel teeth portion 31 of the intermediate gear 3 can be made appropriate.

Moreover, as depicted in FIG. 5, an opposite surface 51a opposite to the inner circumferential portion 61a of the bearing 61 in the direction along the first axis line Ax1 may be formed in the first shaft portion 51. Here, a gap D2 may be provided between the inner circumferential portion 61a and the opposite surface 51a in the direction along the first axis line Ax1. The distance across which the intermediate gear 3 and the bearings 61 can move in the direction along the first axis line Ax1 (for example, the distance across which they can move in the direction toward the opposite gears 2) may be limited within the range of this gap D2. Also by employing this, the backlashes that are the gaps between the tooth 21a of the bevel teeth portion 21 of the opposite gears 2 and the tooth 31a of the bevel teeth portion 31 of the intermediate gear 3 can be made appropriate.

As depicted in FIG. 5, the joint unit 1A may have a first rotation sensor 110 that detects the relative rotation angle of the intermediate gear 3 with respect to the shaft 5 (specifically, the first shaft portion 51) in the circumferential direction of the first axis line Ax1. The first rotation sensor 110 may have the sensor fixed portion 111 fixed to the end portion of the first shaft portion 51 and a sensor rotating portion 112 that is opposite to the sensor fixed portion 111 in the direction along the first axis line Ax1 and rotates together with the intermediate gear 3 in the circumferential direction of the first axis line Ax1. The fixed member 53 may be fixed to the end portion of the first shaft portion 51 as described above. The sensor fixed portion 111 may be fixed to this fixed member 53. That is, the fixed member 53 may support the sensor fixed portion 111. In addition, the sensor rotating portion 112 may be fixed to the lid member 72 that covers the connection member 71.

The first rotation sensor 110 may be a magnetic angle sensor that senses rotation by use of a change in magnetic flux. The sensor fixed portion 111 may be a magnet. The sensor rotating portion 112 may be a sensor substrate on which a Hall integrated circuit (IC) that outputs a signal depending on a change in magnetic flux attributable to the rotation of the sensor fixed portion 111 is mounted. The first rotation sensor 110 is not limited to having such a configuration. The sensor fixed portion 111 may be a sensor substrate, and the sensor rotating portion 112 may be a magnet.

As depicted in FIG. 4, the joint unit 1A may have a second rotation sensor 120 that detects the relative rotation angle of the opposite gear 2 with respect to the shaft 5 (specifically, the second shaft portion 52) in the circumferential direction of the second axis line Ax2. Similarly to the first rotation sensor 110, the second rotation sensor 120 may have a sensor fixed portion 121 fixed to an end portion of the second shaft portion 52 and a sensor rotating portion 122 opposite to the sensor fixed portion 121 in the direction along the second axis line Ax2. The sensor fixed portion 121 may be a magnet. The sensor rotating portion 122 may be a sensor substrate that outputs a signal depending on the rotation of the sensor fixed portion 121. The second rotation sensor 120 is not limited to having such a configuration. The sensor fixed portion 121 may be a sensor substrate, and the sensor rotating portion 122 may be a magnet.

As described above, in the joint unit 1A, the elastic member 80 may bias the opposite surface 33a of the intermediate gear 3 through the bearings 61 in the direction along the first axis line Ax1 (specifically, the direction toward the opposite gears 2). This can bias the intermediate gear 3 in which the opposite surface 33a is formed, in the direction along the first axis line Ax1 (specifically, the direction toward the opposite gears 2). Employing this can reduce the backlashes that are the gaps between the tooth 21a of the bevel teeth portion 21 of the opposite gears 2 and the tooth 31a of the bevel teeth portion 31 of the intermediate gear 3 and suppress the occurrence of noise and vibrations attributable to the backlashes.

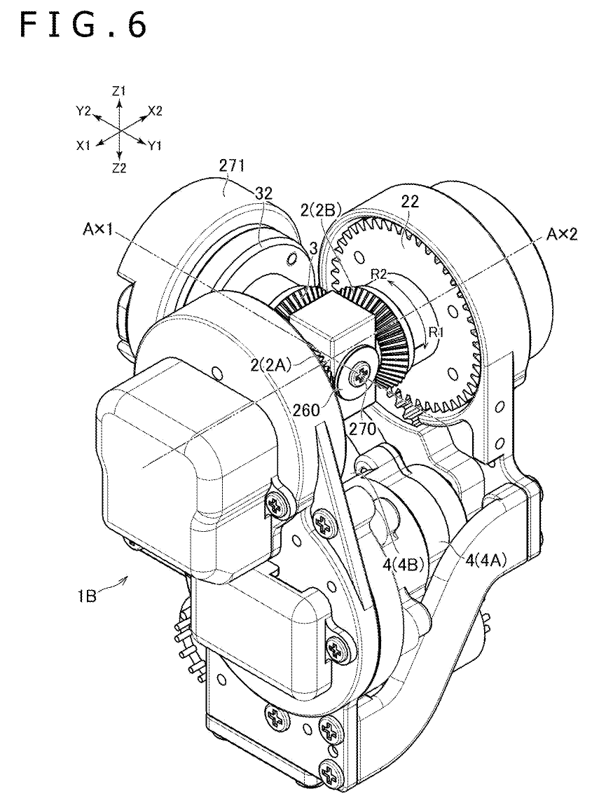

Further, in the joint unit 1A, the fixed member 53 fixed to the end portion of the shaft 5 may have the extending portion 53b that extends along the first axis line Ax1 toward the bearing 61. The distance across which the intermediate gear 3 and the bearings 61 can move in the direction along the first axis line Ax1 may be limited by the end surface 53c of this extending portion 53b. By employing this, the backlashes that are the gaps between the tooth 21a of the bevel teeth portion 21 of the opposite gears 2 and the tooth 31a of the bevel teeth portion 31 of the intermediate gear 3 can be made appropriate.

[2. Second Embodiment] Next, a second embodiment proposed in the present disclosure is described. FIG. 6 is a perspective view depicting a joint unit 1B according to the second embodiment. As depicted in FIG. 6, the joint unit 1B may also have two opposite gears 2 that rotate around the second axis line Ax2 and the intermediate gear 3 that rotates around the first axis line Ax1, similarly to the joint unit 1A described in the first embodiment.

As depicted in FIG. 6, a connection member 271 may be fixed to the intermediate gear 3 in the joint unit 1B. Owing to this, the joint unit 1B can also rotate or move relative to the connection member 271. For example, by the rotation of the two opposite gears 2 in the same direction, the joint unit 1B can move around the second axis line Ax2 relative to a member such as an arm fixed to the connection member 271. Moreover, by the rotation of the two opposite gears 2 in directions opposite to each other, the joint unit 1B can move around the first axis line Ax1 relative to the member such as an arm fixed to the connection member 271.

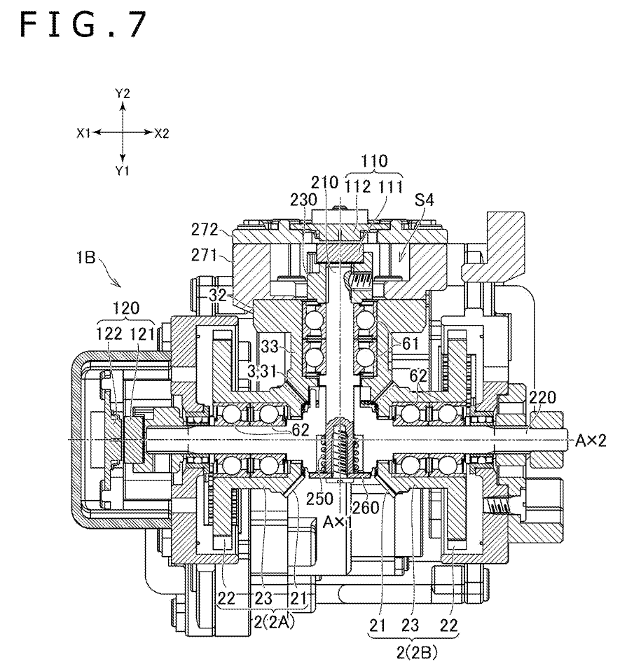

FIG. 7 is a sectional view depicting a section of the joint unit 1B taken along the first axis line Ax1 and the second axis line Ax2. The cutting position of the section depicted in FIG. 7 corresponds to that of the section depicted in FIG. 4. As depicted in FIG. 7, the joint unit 1B may have a first shaft 210 that rotatably supports the intermediate gear 3 and a second shaft 220 that rotatably supports the two opposite gears 2. The first shaft 210 may extend along the first axis line Ax1. The second shaft 220 may extend along the second axis line Ax2. The first axis line Ax1 may intersect the second axis line Ax2 in the joint unit 1B. The first axis line Ax1 may perpendicularly intersect the second axis line Ax2.

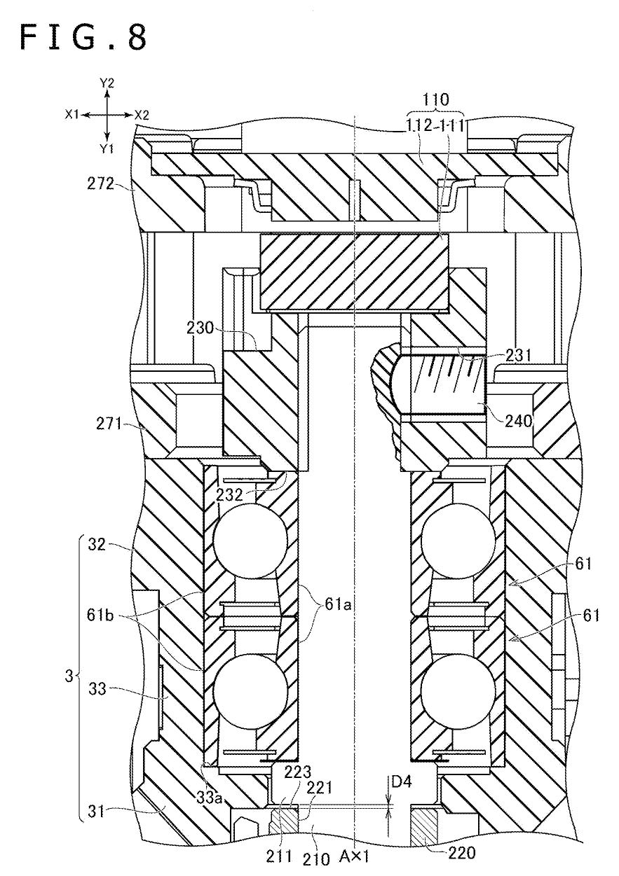

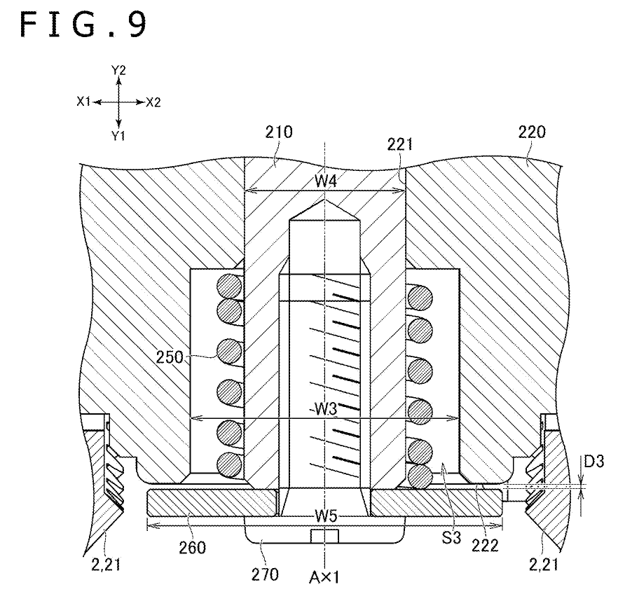

FIGS. 8 and 9 are partially enlarged views of FIG. 7. FIG. 8 depicts one end portion of the first shaft 210. FIG. 9 depicts the other end portion of the first shaft 210. As depicted in FIG. 9, the second shaft 220 may have a housing portion 221 that is a hole or a notch formed along the first axis line Ax1 and houses part of the first shaft 210. The first shaft 210 may penetrate the second shaft 220 in the housing portion 221. This may allow the first shaft 210 to move in the direction along the first axis line Ax1 relative to the second shaft 220.

As depicted in FIGS. 7 and 8, a first fixed member 230 may be fixed to an end portion of the first shaft 210. As depicted in FIG. 8, an attachment hole 231 is formed in the first fixed member 230 in a direction perpendicularly intersecting the first axis line Ax1. Further, a fixing implement 240 such as a screw may be inserted into the attachment hole 231 of the first fixed member 230. This may allow the first fixed member 230 to be fastened to the end portion of the first shaft 210 and move together with the first shaft 210 in the direction along the first axis line Ax1 relative to the second shaft 220.

As depicted in FIG. 8, the first fixed member 230 may be located on the side opposite to the opposite surface 33a formed in the intermediate gear 3 across the bearings 61 in the direction along the first axis line Ax1. The first fixed member 230 may have an opposite surface 232 opposite to the bearing 61 in the direction along the first axis line Ax1. The opposite surface 232 may be in contact with the bearing 61 in the direction along the first axis line Ax1.

As depicted in FIGS. 7 and 9, the joint unit 1B may have an elastic member 250. The elastic member 250 may be a coil spring that is disposed around the first shaft 210 and surrounds the outer circumference of the first shaft 210. The elastic member 250 may be disposed at an end portion of the first shaft 210. The elastic member 250 may be disposed at the end portion on the side opposite to the end portion to which the first fixed member 230 is fixed.

A space S3 may be formed at an end portion of the housing portion 221 as the hole or the notch formed in the second shaft 220. The elastic member 250 may be housed in this space S3. A diameter W3 of the space S3 in the circumferential direction of the first axis line Ax1 may be larger than a diameter W4 of the housing portion 221 in the same direction.

Here, the elastic member 250 may bias the first shaft 210. The first fixed member 230 may be fixed to the first shaft 210 as described above. By the biasing of the first shaft 210 by the elastic member 250, the first fixed member 230 fixed to the first shaft 210 can be biased. Moreover, the first fixed member 230 may be located on the side opposite to the opposite surface 33a of the intermediate gear 3 across the bearings 61 and line up with the bearings 61 in the direction along the first axis line Ax1. Owing to this, by biasing the first fixed member 230 in the direction along the first axis line Ax1 (specifically, the direction toward the opposite gears 2), the bearings 61 and the opposite surface 33a can be biased in the same direction. As a result, the intermediate gear 3 in which the opposite surface 33a is formed can be biased in the direction toward the opposite gears 2. In this manner, the elastic member 250 may bias the opposite surface 33a of the intermediate gear 3 through the first shaft 210, the first fixed member 230, and the bearings 61.

Also by employing this, the intermediate gear 3 in which the opposite surface 33a is formed can be biased in the direction toward the opposite gears 2 by the elastic member 250. This can reduce the backlashes that are the gaps between the tooth 21a of the bevel teeth portion 21 of the opposite gears 2 and the tooth 31a of the bevel teeth portion 31 of the intermediate gear 3 and suppress the occurrence of noise and vibrations attributable to the backlashes.

As depicted in FIGS. 7 and 9, the joint unit 1B may have a second fixed member 260 fixed to the first shaft 210. The second fixed member 260 may be fixed to the end portion of the first shaft 210 by a fixing implement 270 (see FIGS. 6 and 9) such as a screw. As depicted in FIG. 7, the second fixed member 260 may be fixed to the end portion on the side opposite to the end portion to which the first fixed member 230 is attached in the first shaft 210. As depicted in FIG. 9, the second fixed member 260 may be a washer. In this case, the second fixed member 260 may have a hole or a notch with a diameter smaller than that of the first shaft 210. Further, the fixing implement 270 may be inserted, along the first axis line Ax1, into the hole or the notch of the second fixed member 260 and an attachment hole formed along the same direction in the first shaft 210.

As depicted in FIG. 7, the second fixed member 260 may be disposed on the side opposite to the first fixed member 230 across the bearings 61 in the direction along the first axis line Ax1. In addition, the elastic member 250 may cause the second fixed member 260 to be biased in such a direction as to get farther away from the bearing 61. By employing this, the first shaft 210 and the first fixed member 230 can be biased in the direction toward the opposite gears 2. This can bias the bearings 61 and the opposite surface 33a of the intermediate gear 3 in the direction toward the opposite gears 2.

As depicted in FIG. 9, in the direction along the first axis line Ax1, an end surface of the second fixed member 260 fixed to the first shaft 210 may be opposite to an edge 222 of the space S3 in which the elastic member 250 is housed in the housing portion 221 formed in the second shaft 220. Further, a diameter W5 of the second fixed member 260 in the circumferential direction of the first axis line Ax1 may be larger than the diameter W3 of the space S3. Here, a gap D3 may be provided between the edge 222 of the housing portion 221 formed in the second shaft 220 (specifically, the edge 222 of the space S3) and the second fixed member 260. The distance across which the intermediate gear 3 and the bearings 61 can move in the direction along the first axis line Ax1 (for example, the distance across which they can move in the direction opposite to the direction toward the opposite gears 2) may be limited within the range of this gap D3. By employing this, the backlashes that are the gaps between the tooth 21a of the bevel teeth portion 21 of the opposite gears 2 and the tooth 31a of the bevel teeth portion 31 of the intermediate gear 3 can be made appropriate.

Moreover, as depicted in FIG. 8, a protruding portion 211 that protrudes in the circumferential direction of the first axis line Ax1 may be formed in the first shaft 210. The protruding portion 211 formed in the first shaft 210 may be opposite to an edge 223 of the housing portion 221 formed in the second shaft 220 (the edge on the side opposite to the edge 222 depicted in FIG. 9) in the direction along the first axis line Ax1. Here, a gap D4 may be made between the protruding portion 211 and the edge 223 in the direction along the first axis line Ax1. The distance across which the intermediate gear 3 and the bearings 61 can move in the direction along the first axis line Ax1 (for example, the distance across which they can move in the direction toward the opposite gears 2) may be limited within the range of this gap D4. Also by employing this, the backlashes that are the gaps between the tooth 21a of the bevel teeth portion 21 of the opposite gears 2 and the tooth 31a of the bevel teeth portion 31 of the intermediate gear 3 can be made appropriate.

As depicted in FIG. 7, the connection member 271 may be fixed to a base portion 32 of the intermediate gear 3 by a fixing implement such as a screw. This connection member 271 may be fixed to an arm of a robot or a member different from an arm of a robot. Further, the connection member 271 may be formed into a cylindrical shape, and a lid member 272 may be attached to an end portion thereof. A space S4 for housing the first fixed member 230 may be made inside the connection member 271 formed into the cylindrical shape.

In the present embodiment, to the end portion of the first shaft 210, the first fixed member 230 depicted in FIG. 8 is attached instead of the fixed member 53 depicted in FIG. 5. Here, the elastic member 250 for biasing the intermediate gear 3 is disposed inside the space S3 formed in the second shaft 220. Thus, a space for housing the elastic member 250 does not have to be provided in the first fixed member 230. This allows the first fixed member 230 to have a smaller size than the fixed member 53 in which the space S1 for housing the elastic member 80 depicted in FIG. 5 is formed. In association with this, the size of the connection member 271 that houses the first fixed member 230 can also be made smaller than that of the connection member 71 that houses the fixed member 53.

Moreover, as depicted in FIG. 7, similarly to the joint unit 1A, the joint unit 1B may also have the first rotation sensor 110 that detects the relative rotation angle of the intermediate gear 3 with respect to the first shaft 210 in the circumferential direction of the first axis line Ax1. The first rotation sensor 110 may have the sensor fixed portion 111 fixed to the end portion of the first shaft 210 and the sensor rotating portion 112 that is opposite to the sensor fixed portion 111 in the direction along the first axis line Ax1 and rotates together with the intermediate gear 3 in the circumferential direction of the first axis line Ax1. The sensor fixed portion 111 may be fixed to the first fixed member 230. The first fixed member 230 may support the sensor fixed portion 111. The sensor rotating portion 112 may be attached to the lid member 272 as in the example depicted in FIG. 5.

As described above, in the joint unit 1B according to the present embodiment, the bearings 61 may be biased in the direction toward the opposite gears 2 through the first fixed member 230 fixed to the first shaft 210, by biasing the first shaft 210 (specifically, the second fixed member 260 fixed to the first shaft 210) by the elastic member 250 in the direction along the first axis line Ax1. Also by employing this, the intermediate gear 3 in which the opposite surface 33a is formed can be biased in the direction toward the opposite gears 2 by the elastic member 250 and the bearings 61. This can reduce the backlashes that are the gaps between the tooth 21a of the bevel teeth portion 21 of the opposite gears 2 and the tooth 31a of the bevel teeth portion 31 of the intermediate gear 3 and suppress the occurrence of noise and vibrations attributable to the backlashes.

Further, in the joint unit 1B, the distance across which the intermediate gear 3 and the bearings 61 can move in the direction along the first axis line Ax1 may be limited within the range of the gap D3 between the edge 222 of the housing portion 221 formed in the second shaft 220 (specifically, the edge 222 of the space S3) and the second fixed member 260. By employing this, the backlashes that are the gaps between the tooth 21a of the bevel teeth portion 21 of the opposite gears 2 and the tooth 31a of the bevel teeth portion 31 of the intermediate gear 3 can be made appropriate.

[3. Modification] The present disclosure is not limited to the joint units 1A and 1B described above, and various changes may be made. For example, in the first and second embodiments, the description has been given of the examples in which the backlashes between the intermediate gear 3 and the two opposite gears 2 are reduced by biasing the intermediate gear 3 by the elastic member in the direction along the first axis line Ax1. The joint unit is not limited to having such a configuration. The backlashes that are the gaps between the tooth 21a of the bevel teeth portion 21 of the two opposite gears 2 and the tooth 31a of the bevel teeth portion 31 of the intermediate gear 3 may be reduced by biasing the two opposite gears 2 by elastic members in the direction along the second axis line Ax2 (specifically, the direction toward the side on which the bevel teeth portion 31 of the intermediate gear 3 is disposed).

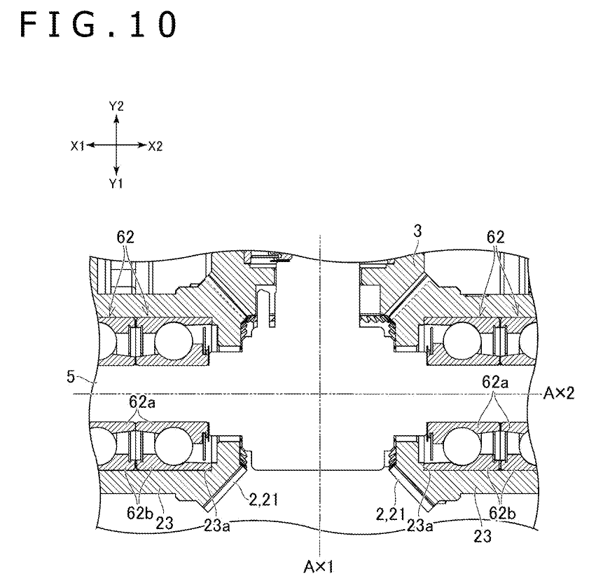

FIG. 10 is a sectional view depicting a section of part of a joint unit according to a modification. As depicted in FIG. 10, each of the two opposite gears 2 may have an opposite surface 23a opposite to the bearing 62 in the direction along the second axis line Ax2. The opposite surfaces 23a may be in contact with the bearing 62 in the direction along the second axis line Ax2. The bearings 62 may have an inner circumferential portion 62a and an outer circumferential portion 62b, similarly to the bearings 61. The opposite surfaces 23a may be opposite to only the outer circumferential portion 62b, out of the inner circumferential portion 62a and the outer circumferential portion 62b of the bearing 62, and be in contact with only the outer circumferential portion 62b. Moreover, each opposite gear 2 may have the cylindrical portion 23 extending along the second axis line Ax2, and the opposite surface 23a may be formed inside this cylindrical portion 23.

Here, the elastic members (not depicted) may bias the opposite surface 23a through the bearings 62 in the direction along the second axis line Ax2 (specifically, the direction toward the side on which the bevel teeth portion 31 of the intermediate gear 3 is disposed). This can bias the opposite gears 2 in which the opposite surface 23a is formed, in the direction toward the side on which the bevel teeth portion 31 of the intermediate gear 3 is disposed. For example, the elastic members may be disposed on the side opposite to the opposite surface 23a across the bearings 62. Employing this can also reduce the backlashes that are the gaps between the tooth 21a of the bevel teeth portion 21 of the two opposite gears 2 and the tooth 31a of the bevel teeth portion 31 of the intermediate gear 3.

In addition, the elastic members may push only the inner circumferential portion 62a, out of the inner circumferential portion 62a and the outer circumferential portion 62b of the bearing 62. Employing this allows the elastic members to bias the opposite surface 23a of the opposite gear 2 that is rotating around the second axis line Ax2, without rotating around the second axis line Ax2. This can bias the opposite gears 2 by the elastic members in the direction toward the side on which the bevel teeth portion 31 of the intermediate gear 3 is disposed while suppressing the occurrence of friction between the elastic member and another member.

[4. Summary] (1) As described above, the joint unit described in the embodiments of the present disclosure may include two opposite gears that are two bevel gears opposite to each other, an intermediate gear that is a bevel gear that meshes with both of the two opposite gears, a first shaft that rotatably supports a first gear that is any gear of the two opposite gears and the intermediate gear, a bearing disposed between the first gear and the first shaft, and an elastic member. The first gear may have an opposite surface opposite to the bearing in a direction along a first axis line defined in the first shaft. The elastic member may bias the opposite surface through the bearing in the direction along the first axis line. This configuration makes it possible to inhibit a backlash from becoming large with a gear having a simple structure.

(2) In the joint unit of (1) above, the bearing may have an inner circumferential portion in contact with the first shaft and an outer circumferential portion in contact with the first gear. The elastic member may bias the inner circumferential portion of the bearing. The outer circumferential portion of the bearing may bias the opposite surface.

(3) The joint unit of (1) or (2) above may further include a first fixed member fixed to the first shaft. The elastic member may be disposed between the first fixed member and the bearing.

(4) The joint unit of any one of (1) through (3) above may further include a second shaft that rotatably supports a second gear that is a gear different from the first gear among the two opposite gears and the intermediate gear, and a first fixed member fixed to the first shaft. The first axis line may intersect a second axis line defined in the second shaft. The first fixed member may be located on a side opposite to the opposite surface across the bearing in the direction along the first axis line. The first shaft and the first fixed member may be capable of moving relative to second shaft in the direction along the first axis line. The elastic member may bias the first shaft.

(5) The joint unit of (4) above may further include a second fixed member fixed to the first shaft. The second fixed member may be located on a side opposite to the first fixed member across the bearing in the direction along the first axis line. The elastic member may be disposed between the bearing and the second fixed member. The elastic member may cause the second fixed member to be biased in such a direction as to get farther away from the bearing.

(6) In the joint unit of any one of (1) through (5) above, the first gear and the bearing may be permitted to move in the direction along the first axis line only across a distance shorter than an amount of deformation of the elastic member. This configuration makes it possible to make the backlashes between the opposite gears and the intermediate gear appropriate.

(7) In the joint unit of (3) above, the first fixed member may have a fixed portion fixed to an end portion of the first shaft and an extending portion that extends from the fixed portion toward the bearing. A distance across which the first gear and the bearing are capable of moving in the direction along the first axis line may be limited by an end surface of the extending portion.

(8) The joint unit of (7) above may further include a movable member that is disposed between the end surface and the bearing and is capable of moving along the first axis line between the end surface and the bearing. The distance across which the first gear and the bearing are capable of moving in the direction along the first axis line may be limited within a range of a gap between the end surface and the movable member.

(9) The joint unit of (7) or (8) above may further include a rotation sensor that detects a relative rotation angle of the first gear with respect to the first shaft. The rotation sensor may have a sensor fixed portion fixed to the end portion of the first shaft and a sensor rotating portion that is opposite to the sensor fixed portion in the direction along the first axis line and rotates together with the first gear. The first fixed member may support the sensor fixed portion.

(10) In the joint unit of any one of (7) through (9) above, the first fixed member may have a recessed portion opened in a direction toward a side on which the bearing is disposed. The elastic member may be housed in the recessed portion.

(11) In the joint unit of (5) above, the second shaft may have a hole portion that houses part of the first shaft. A distance across which the first gear and the bearing are capable of moving in the direction along the first axis line may be limited within a range of a gap between an edge of the hole portion and the second fixed member.

(12) In the joint unit of any one of (1) through (11) above, the first gear may be the intermediate gear. The elastic member may bias the intermediate gear toward the two opposite gears.

It should be understood by those skilled in the art that various modifications, combinations, sub-combinations and alterations may occur depending on design requirements and other factors insofar as they are within the scope of the appended claims or the equivalents thereof.

What is claimed is:

1. A joint unit comprising:
two opposite gears that are two bevel gears opposite to each other;
an intermediate gear that is a bevel gear that meshes with both of the two opposite gears;
a first shaft that rotatably supports a first gear that is any gear of the two opposite gears and the intermediate gear;
a bearing disposed between the first gear and the first shaft; and
an elastic member, wherein:
the first gear has an opposite surface opposite to the bearing in a direction along a first axis line defined in the first shaft; and
the elastic member biases the opposite surface through the bearing in the direction along the first axis line.

2. The joint unit according to claim 1, wherein:
the bearing has an inner circumferential portion in contact with the first shaft and an outer circumferential portion in contact with the first gear;
the elastic member biases the inner circumferential portion of the bearing; and
the outer circumferential portion of the bearing biases the opposite surface.

3. The joint unit according to claim 1, further comprising a first fixed member fixed to the first shaft, wherein the elastic member is disposed between the first fixed member and the bearing.

4. The joint unit according to claim 1, further comprising:
a second shaft that rotatably supports a second gear that is a gear different from the first gear among the two opposite gears and the intermediate gear; and
a first fixed member fixed to the first shaft, wherein:
the first axis line intersects a second axis line defined in the second shaft;
the first fixed member is located on a side opposite to the opposite surface across the bearing in the direction along the first axis line;
the first shaft and the first fixed member are capable of moving relative to second shaft in the direction along the first axis line; and
the elastic member biases the first shaft.

5. The joint unit according to claim 4, further comprising:
a second fixed member fixed to the first shaft, wherein:
the second fixed member is located on a side opposite to the first fixed member across the bearing in the direction along the first axis line;
the elastic member is disposed between the bearing and the second fixed member; and
the elastic member causes the second fixed member to be biased in such a direction as to get farther away from the bearing.

6. The joint unit according to claim 1, wherein the first gear and the bearing are permitted to move in the direction along the first axis line only across a distance shorter than an amount of deformation of the elastic member.

7. The joint unit according to claim 3, wherein:
the first fixed member has a fixed portion fixed to an end portion of the first shaft and an extending portion that extends from the fixed portion toward the bearing; and
a distance across which the first gear and the bearing are capable of moving in the direction along the first axis line is limited by an end surface of the extending portion.

8. The joint unit according to claim 7, further comprising:
a movable member that is disposed between the end surface and the bearing and is capable of moving along the first axis line between the end surface and the bearing, wherein the distance across which the first gear and the bearing are capable of moving in the direction along the first axis line is limited within a range of a gap between the end surface and the movable member.

9. The joint unit according to claim 7, further comprising:
a rotation sensor that detects a relative rotation angle of the first gear with respect to the first shaft, wherein:
the rotation sensor has a sensor fixed portion fixed to the end portion of the first shaft and a sensor rotating portion that is opposite to the sensor fixed portion in the direction along the first axis line and rotates together with the first gear; and
the first fixed member supports the sensor fixed portion.

10. The joint unit according to claim 7, wherein:
the first fixed member has a recessed portion opened in a direction toward a side on which the bearing is disposed; and
the elastic member is housed in the recessed portion.

11. The joint unit according to claim 5, wherein:
the second shaft has a hold portion that houses part of the first shaft; and
a distance across which the first gear and the bearing are capable of moving in the direction along the first axis line is limited within a range of a gap between an edge of the hole portion and the second fixed member.

12. the joint unit according to claim 1, wherein:
the first gear is the intermediate gear; and
the elastic member biases the intermediate gear toward the two opposite gears.
